(19) United States
(12) Patent Application Publication
(10) Pub. No.: US 2021/0232916 A1
(43) Pub. Date: Jul. 29, 2021

(54) APPARATUS FOR OPERATING A NEURAL NETWORK, CORRESPONDING METHOD AND COMPUTER PROGRAM PRODUCT

(71) Applicant: STMicroelectronics S.r.l., Agrate Brianza (IT)

(72) Inventor: Amedeo Veneroso, Caserta (IT)

(21) Appl. No.: 17/156,158

(22) Filed: Jan. 22, 2021

(30) Foreign Application Priority Data
Jan. 24, 2020 (IT) 102020000001462

(51) Int. Cl. G06N 3/08; G06F 9/445; H04L 9/30; H04L 29/08

(52) U.S. Cl. CPC G06N 3/08; H04L 67/28; H04L 9/30; G06F 9/445

(57) ABSTRACT

An embodiment apparatus comprises a first processing system executing a first portion of a neural network comprising a first subset of a set of neural network layers providing a first intermediate output, and a second processing system receiving the first intermediate output, and operating a second portion of the neural network comprising a second subset of the set of layers providing a respective output, the second processing system configured to supply to the first processing system an output information function of the respective output, and the first processing system configured to obtain as a function of the output information a final output of the neural network. The second processing system includes a secure element storing a model of the second portion, and executes the second portion by applying the input information to the model of the second portion to provide the respective output.

### CROSS-REFERENCE TO RELATED APPLICATIONS

This application claims the benefit of Italian Application No. 102020000001462, filed on Jan. 24, 2020, which application is hereby incorporated herein by reference.

### TECHNICAL FIELD

Embodiments of the present disclosure relate to solutions for operating a neural network. Embodiments of the present disclosure relate in particular to solution for operating a neural network in a mobile device.

### BACKGROUND

A neural network (NN) is a computational architecture that attempts to identify underlying relationships in a set of data by using a process that mimics the way the human brain operates. Neural networks have the ability of adapting to changing inputs so that a network may produce a best possible result without redesigning the output criteria.

Neural networks are widely used e.g. to extract patterns and detect trends that are too complex to be noticed by either humans or other computer techniques.

With reference to FIG. 1, where an apparatus 10 operating a neural network XNN is schematically shown, from a formal viewpoint, a neural network architecture may be described as a network or graph, comprising a plurality of nodes, which are the neural network cells, coupled by edges or connections inputting and outputting each cell. Each edge or connection is associated with a respective weight so that the cell may perform a linear combination of the inputs to obtain an output value. Each cell may also include an activation function to control the amplitude of the output of the cell. Thresholds values and bias values may also be associated to the cells, in a manner per se known.

In FIG. 1 is shown an example of neural network XNN of the type MultiLinear Perceptron or Deep Feed Forward, in which cells aᵢ^{(k)} are grouped as in the most part of the neural networks in successive levels, called layers Lₖ, with index k=0, . . . , M such that there are connections only from the cells of a layer to the cells of the successive layer.

Cells of the first layer L0 represent input cells, which have no antecedent and usually do not implement weights or activation functions, just retain the input values.

Thus, even if—strictly speaking—they are not computing cells and represent only entry points for the information into the network, are called input cells and input layer IL.

For instance, input data to the input cells may be images, but also other kinds of digital signals: acoustic signals, bio-medical signals, inertial signals from gyroscopes and accelerometers may be exemplary of these.

The output cells, which form in FIG. 1 an output layer OL, i.e. layer L_{M} may be computing cells whose results constitute the output of the network.

Finally, the cells in the other layers L₁. . . L_{M-1} are computing cells which are usually defined as hidden cells in hidden layers HL. In one or more embodiments, the direction of propagation of the information may be unilateral e.g. of a feed-forward type, starting from the input layer and proceeding through the hidden layers up to the output layer.

Assuming that the network has L layers, one may adopt, as indicated above, the convention of denoting the layers with k=1, 2, . . . , M, starting from the input layer, going on through the hidden layers up to the output layer.

By considering the layer Lₖ, in a possible notation:

uₖ: denotes the number of cells of the layer k,

aᵢ^{(k)}i=1, . . . , uₖ: denotes a cells of layer k or equivalently its value,

W^{(k)}: denotes the matrix of the weights from the cells of layer k to the cells of layer (k+1); it is not defined for the output layer.

The values aᵢ^{(k)}i=1, . . . , uₗ are the results of the computation performed by the cells, except for the input cells, for which the values aᵢ⁽⁰⁾i=1, . . . , uₗ are the input values of the network. These values represent the activation values, o briefly, the “activations” of the cells.

The element (i,j) of matrix W^{(k)} is the value of the weight from the cell aᵢ^{(k)} to the cell aⱼ^{(k+1)}.

Moreover, for each layer k=1, . . . , (M−1), an additional cell aᵤ_{ₖ}₊₁^{(k)}, denoted as the bias unit can be considered (e.g. with a value fixed to 1) which allows shifting the activation function to the left or right.

A computing cell aᵢ^{(k+1)} may perform a computation which can be described as a combination of two functions:
an activation function ƒ, which may be a non-linear monotonic function, such as a sigmoidal function, or a rectifier function (a unit employing a rectifier function is called a rectified linear unit or ReLU), and
a function gᵢ specifically defined for the cell which takes as values the activations of the previous layer and the weights of the current layer gᵢ(a₁^{(k-1)}, a₂^{(k-1)}, . . . , aᵤ_{_{k−1}}₊₁^{(k)}, W^{(k)}).

In one or more embodiments, operation (execution) of a neural network as exemplified herein may involve a computation of the activations of the computing cells following the direction of the network, e.g. with propagation of information from the input layer to the output layer. This procedure is called forward propagation.

FIG. 1 is exemplary of a network arrangement as discussed in the foregoing, including M+1 layers, including an input layer IL (layer 0), hidden layers HL (e.g. layer 1, layer 2, . . . ) and an output layer OL (layer L).

In mobile and IoT (Internet of Things) applications, neural network inference may be performed on the mobile/IoT/component. In some other, e.g. voice recognition, it is uploaded the data, e.g. voice, on a cloud and the neural network is performed on the cloud; one approach, actually, is to have the neural network in the mobile phone to reduce cloud overallocation. In mobile devices, however, sometimes resources are not enough to perform Deep Neural network Inferences.

It is known in the Google mobile framework an implementation called TensorFlow Lite, where it has been defined a delegate model in which part of the network computation is performed by an external device, such as a GPU (Graphical Processing Unit), as described in https://www.tensorflow.org/lite/performance/gpu.

Delegation works with the concept that the entire or pails of the neural network computation is delegated to an external device, typically a GPU (Graphic Processing Unit) for faster execution.

This is based on the layered nature of the neural networks: a subset of the layers execution is moved to the GPU.

In FIG. 2 it is schematized an example of such technique.

The neural network XNN, comprising a set of neural network layers IL, OL, HL is operated by an apparatus including a first processing system 11 represented by an application processor, for instance of a mobile phone, which receives input information IV or input values operates a first portion, NN1, of the neural network XNN comprising a first subset of the set of layers, for instance the input layer IL, which includes the input information obtaining a first intermediate output II, which is in this case the output of the input layer IL. The application processor then feed the first intermediate output II as input to an external processing system 23, external to the first processing system 11, preferably a GPU, which executes a second portion NN2 of the neural network XNN, comprising a second subset of the set of layers, for instance the hidden layers HL and the output layer OL, using as input the first intermediate output II to compute a second intermediate output OI, which is then supplied the output information to the first processing system 11, which supplies it as final output information OV or output values of the whole apparatus for operating the neural network.

Neural networks are however expanding their application range from computer vision/user interaction to security oriented services such as:
Biometry
Authentication
User Privacy (like voice recognition).

To this last regard, as the voice recognition is done typically by first recording the voice, the recorded voice is of course privacy critical.

An inconvenience of the neural networks like ones described previously is that the neural network structure and weights are vulnerable to attacks and the communication between the application processing system and the external processing system adds a point of vulnerability.

In addition, if the neural network is stored in a memory that can be easily tampered, it can be easily cloned; in literature are reported watermarking techniques that detect cloning but do not prevent it.

### SUMMARY

On the basis of the foregoing description, the need is felt for solutions which overcome one or more of the previously outlined drawbacks.

According to one or more embodiments, such an object is achieved through an apparatus having the features specifically set forth in the claims that follow. Embodiments moreover concerns a related method for operating a neural network as well as a corresponding related computer program product, loadable in the memory of at least one computer and including software code portions for performing the steps of the method when the product is run on a computer. As used herein, reference to such a computer program product is intended to be equivalent to reference to a computer-readable medium containing instructions for controlling a computer system to coordinate the performance of the method. Reference to “at least one computer” is evidently intended to highlight the possibility for the present disclosure to be implemented in a distributed/modular fashion.

The claims are an integral part of the technical teaching of the disclosure provided herein.

As mentioned in the foregoing, the present disclosure provides solutions regarding an apparatus for operating a neural network comprising a set of neural network layers (IL, OL, HL), the apparatus comprising:
a first processing system executing a first portion of the neural network comprising a first subset of the set of layers obtaining a first intermediate output,
a second processing system, external to the first processing system, configured to receive as input the first intermediate output of the first portion and configured to operating a second portion of the neural network comprising a second subset of the set of layers, obtaining a respective output, the second processing system being configured to supply to the first processing system output information function of the respective output, the first processing system being configured to obtain as a function of the output information a final output of the neural network,
wherein the second processing system includes a secure element in which a model of the second portion, and wherein the second processing system is configured to execute the second portion stored in the secure element of the neural network applying the input information to the model of the second portion to obtain the respective output.

In variant embodiments, in the secure element is stored an application comprising the model of the second portion executable by the second processing system.

In variant embodiments, the apparatus here described may include that the application includes a command to feed the input information to the model of the second portion.

In variant embodiments, the apparatus here described may include that the application includes an inference engine receiving the respective output and outputting predictions.

In variant embodiments, the apparatus here described may include that the model of the second portion includes an output layer, in particular a classifier.

In variant embodiments, the apparatus here described may include that the first processing system include a further proxy application which is configured to operate as an interface to the second processing system and the second secure element, obtaining the first intermediate output and supplying it to the second processing system and secure element and receiving the output information function of the respective output from the second processing system.

In variant embodiments, the apparatus here described may include that the application comprising a model of the second portion includes a velocity mechanism which limits the number of executions performable by the application to a given limit number of executions, in particular includes a counter set to the given limit number of executions, the application comprising a model of the second portion being configured to stop when the counter reaches the given limit number of executions.

In variant embodiments, the apparatus here described may include that the secure element is one of: a UICC, an eUICC, an eSE, or a removable memory card.

In variant embodiments, the apparatus here described may include that the first processing system is the processor of a mobile device and the second processing system comprising the secure element is an integrated card in the mobile device.

The present disclosure provides also solutions regarding a method for executing a neural network comprising a set of layers in an apparatus according to any of the previous apparatus embodiments comprising:
dividing a trained neural network in a first portion comprising a first set of layers and a second portion comprising a second set of layers,
storing the first portion in a first processing system, in particular in a memory accessible by the first processing system, for operation by the first processing system,
storing an application comprising a model of the second portion in a secure element associated to a second processing system external to the first processing system, in particular the model comprising a description of the cells, connections and their properties, in particular weights and functions associated to the cells and connections, of the second portion of neural network,
operating the first portion obtaining a first intermediate output,
supplying the first intermediate output as intermediate input to the application comprising a model of the second portion in the secure element, in particular by the proxy application,
executing in the secure element the second portion obtaining a respective output, and
supplying to the first processing system output information function of the respective output.

In variant embodiments, the method here described may include the supplying to the first processing system output information function of the respective output include one of the following:
feeding the respective output to the inference engine to obtain predictions, which are sent back as intermediate output information OI to the first processing system to be outputted as final information,
taking as the first intermediate output the output of the hidden layers of the neural network, or
taking as the first intermediate output the output of an output layer, in particular a classifier, stored inside the application.

In variant embodiments, storing an application comprising a model of the second portion in a secure element may include remotely delivering the model by a secure channel or a confidential channel to the secure element.

In variant embodiments, storing an application comprising a model of the second portion in a secure element may include loading the model in the secure element using OTA (Over The Air) remote provisioning.

In variant embodiments, the method here described may include an OTA server loads in the secure element the application comprising a model of the second portion encrypted with a given key specific of the secure element, the secure element being configured to decrypt with the given key such second portion and to perform the executing step.

The present disclosure provides also solutions regarding a computer-program product that can be loaded into the memory of at least one processor and comprises portions of software code for implementing the method of any of the previous embodiments.

### BRIEF DESCRIPTION OF THE DRAWINGS

Embodiments of the present disclosure will now be described with reference to the annexed drawings, which are provided purely by way of non-limiting example and in which:

FIGS. 1 and 2 have been already described in the foregoing;

FIG. 3 shows schematically an apparatus according to an embodiment; and

FIG. 4 shows a flow diagram flow illustrating operations of an embodiment of a method operating the apparatus here described.

### DETAILED DESCRIPTION OF ILLUSTRATIVE EMBODIMENTS

In the following description, numerous specific details are given to provide a thorough understanding of embodiments. The embodiments can be practiced without one or several specific details, or with other methods, components, materials, etc. In other instances, well-known structures, materials, or operations are not shown or described in detail to avoid obscuring aspects of the embodiments.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The headings provided herein are for convenience only and do not interpret the scope or meaning of the embodiments.

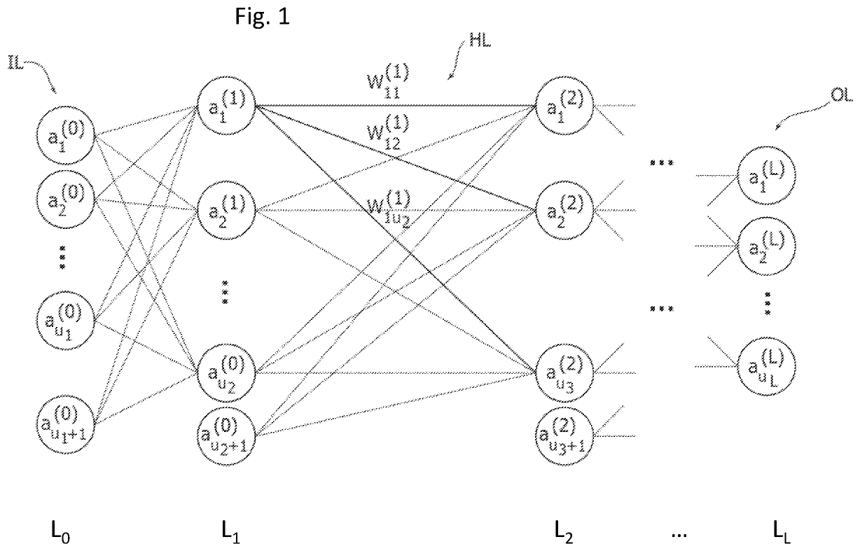

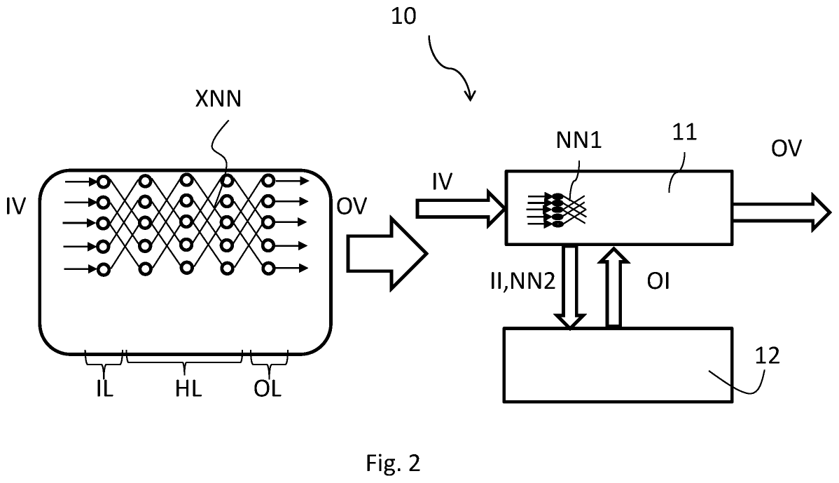

Figures parts, elements or components which have already been described with reference to FIGS. 1 and 2 are denoted by the same references previously used in such Figures; the description of such previously described elements will not be repeated in the following in order not to overburden the present detailed description.

The solution here described in brief uses a first processing system to operate a first portion of the neural network and uses a secure element in a second processing system to operate a second portion of the neural network, possibly also to execute neural network inference.

A Secure Element is a tamper-resistant platform capable of securely hosting applications and their confidential and cryptographic data in accordance with the rules and security requirements set forth by a set of identified trusted authorities.

For instance, the secure platform GlobalPlatform refers to the definition, which may be also defined as a tamper-resistant combination of hardware, software, and protocols capable of embedding smart card-grade applications.

Typical implementations include UICC (Universal Integrated Circuit Card) and eUICC (embedded Universal Integrated Circuit Card), embedded Secure Element (eSE), and removable memory cards.

As many neural networks are very large and simple execution on a secure element would be slow, the apparatus here described stores the second portion in an application in a secure element and the second processing system is configured to execute the second portion stored in the application in the secure element of the neural network on the basis of input information which includes intermediate information supplied by first portion operated by the first processing system. Therefore the second portion of the neural network, or delegated portion, is stored in an application, specifically an applet, either by pre-loading, e.g. at the OEM or card maker, or by using OTA (Over The Air) remote provisioning, and supplying the output information to the first processing system, which supplies it as output of the device

Thus, despite the limitation of the secure elements in terms of computation/memory capacity, the solution exploits that neural networks of specified size can be executed, in particular for neural networks with a low dimension of input parameters, which is also a recurrent feature of security based networks (e.g. a Multi Layer Perceptron, MLP).

Therefore the apparatus and method here described protect the input information and the weights of the neural network, by storing a neural network portion, preferably the hidden layers and the inference engine, in an application or applet in a secure element in an apparatus which is configured to run applets in a secure elements, such as a mobile device using eSEs or integrated cards such as UICC and eUICC.

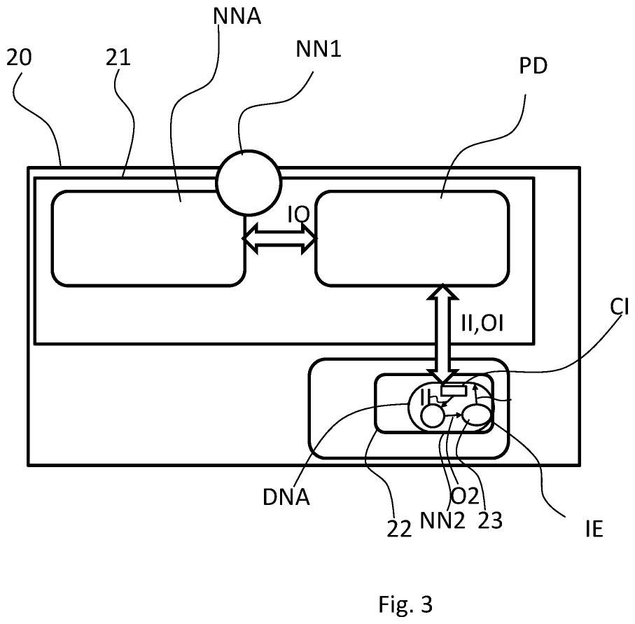

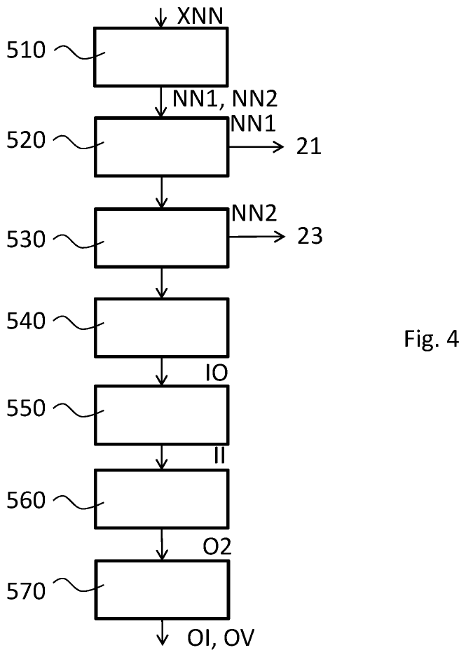

In FIG. 3 it is shown schematically an embodiment of the apparatus here described. With the numeric reference 20 is indicated an apparatus for executing a neural network represented by a mobile phone handset.

The mobile phone handset 20 includes an application processor 21 which is configured to execute applications, among which is comprised an application with neural network NNA. The application with neural network NNA is an application, which for instance may be a secure sensitive application that contains some part of artificial intelligence based elaboration, specifically a neural network XNN. The neural network XNN, as shown in FIG. 1, may be represented by a sequence of layers, comprising an input layer Il, a set of hidden layers HL and an output layer OL. The neural network XNN is not fully contained in the application with neural network NNA, which contains only a first portion NN1, but it is partly delegated to a proxy delegator application PD which is also executed in the application processor 21. In other words, a first portion NN1 of the neural network XNN, for instance comprising the input layer IL and the output layer OL, is executed in the application with neural network NNA, while a second portion NN2 of the neural network NN, for instance comprising the set of hidden layers HL, is managed by the proxy delegator application PD. The proxy delegator application PD is in the example shown as an additional application, e.g. is another application in the Android Package APK to which the Application with Neural Network ANN delegates part of the computation of the neural network NN. In variant embodiments, the proxy delegator can be embodied by another application in the same APK (allowed by the APK), a service, an agent, an application in another APK communicating via socket. , etc. >> Of course, the proxy delegator application PD in FIG. 3 is shown just for explanation as logically separated from the main application. Preferably the proxy delegator application PD is integrated with the application with neural network NNA.

The apparatus 20, in the example mobile phone handset, 20 includes a SIM card 22 which comprises a secure element 23. In the secure element 23 is pre-loaded or stored by remote provisioning by a secure or confidential channel, specifically by OTA, a delegated neural network applet DNA.

Such delegated neural network applet DNA has an architecture, which includes:
an array of neural network layers representing the second portion NN2 of the neural network NN, in the example the set of hidden layers of the neural network NN. Such array includes the structure of the set of hidden layers, i.e. the number of neurons and the connections, and the weights applied by each neuron to its input vector, and
a command CI delivering an intermediate input information II, received from the proxy delegator application PD, to the array containing the second portion NN2 of the neural network NN, i.e. the delegated neural network and returning an delegated output information OI to proxy delegator application PD.

The delegated neural network applet DNA architecture may also comprise an inference engine IE, which is a module configured to operate with the portion NN2 of the neural network NN to perform predictions on the basis of the information supplied by the hidden layers HL. In FIG. 3 it is shown that the inference engine IE supplies the intermediate output information IO, although in different embodiments the intermediate output information IO may be taken as output of the hidden layers HL or as output of an output layer, e.g. a classifier, stored inside the delegated neural network applet DNA. In the latter case the application with neural network NNA may not include an output layer OL.

Thus the proxy delegator application PD is configured to interact with the SIM card 22 comprising a secure element 23 storing the delegated neural network applet DNA to execute the computation of the second portion NN2, i.e. the delegated portion, of the neural network NN. The proxy delegator application PD supplies the intermediate input information II, which preferably is the information from the input layer IL of the neural network XNN, to the delegated neural network applet DNA stored in the secure element 23, which is thus securely executed, returning the delegated output information OI to the proxy delegator application PD, which supplies it as output information of the neural network XNN.

The second portion NN2 is either preloaded in the secure element 23 by storing it for instance at the OEM, or loaded over the air (OTA) by a remote server in the secure element 23.

The OTA operation requires a remote server that manages over the air, this is typical in case of remote provisioning of secure element such eSE or eUICC.

OTA loading/update of the secure element 23 can be performed by re-using existing OTA protocols. By way of example, the delegated neural network applet DNA comprising the neural network structure of the second portion NN2 is simply stored in a file or in an application memory, so the loading is performed by Remote file management or Remote applet management as per ETSI TS 102 226.

Having an OTA management allows the provider to update the delegated neural network applet DNA in case of need or to download it only when needed, e.g. when the corresponding service is allocated on the phone

A Secure Element Remote Application Management protocol, which is a protocol to download application on the mobile phone used by several devices, e.g. NFC wallets, as described by Global Platform (at the URL https://globalplatform.org/specs-library/secure-element-remote-application-management-v1-0-1/) may allow also to have the applet installed on the mobile phone to carry an encrypted script for the specific Secure Element that contains the neural network download/update

Thus, summing up the apparatus 20 is configured to perform a method, indicated with 500 in the exemplary embodiment represented by the flow diagram shown in FIG. 5, which includes:
dividing 510 a trained neural network, e.g. the network XNN, in a first portion NN1 comprising a first set of layers, for instance the input layer IL, and a second portion comprising a second set of layers, for instance comprising the hidden layers HL,
storing 520 the first portion NN1, in the first processing system 21 for instance in a memory, in particular accessible to the first processing system 21, in the example a processor in a mobile device, for operation by such first processing system 21,
storing 530 the application DNA comprising a model of the second portion NN2 in the secure element 23, e.g. a eUICC, associated to a second processing system 22, i.e. the processor of the card, external to the first processing system 21, in particular such model comprising a description of the network or graphs and its cells, e.g. cells aᵢ^{(k)}, layers Lₖ and number of cells of the layer k uₖ, connections, i.e. edge of the graph, and weights, e.g. W^{(k)} the matrix of the weights from the cells of layer k to the cells of layer (k+1) and possibly also bias units aᵤ_{ₖ}₊₁^{(k)}, as well as the computation performed by the cells, e.g. combinations of the activation functions ƒ and the propagation function gᵢ specifically defined for a given cell which takes as values the activations of the previous layer and the weights of the current layer gᵢ(a₁^{(k-1)}, a₂^{(k-1)}, . . . , aᵤ_{_{k−1}}₊₁^{(k)}, W^{(k)}), in other words a description of the nodes and edges and the respective parameters and functions of the second portion NN2 of the neural network XNN,
operating 540 the first portion NM obtaining a first intermediate output IO, e.g. the output of the input layer IL, in particular by the proxy application PD, which is an interface for exchanging data or information with the specific secure element 23 and second processing system 21 which are used as external system,
supplying 550 the first intermediate output IO as intermediate input II to the delegated neural network applet DNA in the secure element 123, again preferably the proxy application PD, and
executing 560 the second portion NN2 obtaining a respective output O2.

With 570 is indicated a further step including supplying to the first processing system 21, in particular through the proxy PD, the output information OI function of the respective output O2. In the example shown in particular the step 570 includes feeding the respective output O2 to the inference engine IE to obtain predictions, which are sent back as intermediate output information OI to the first processing system 21 to be outputted as final information OV.

In variant embodiments the step 570 may include taking as the first intermediate output IO the output of the hidden layers HL of the neural network XNN.

In further variant embodiments the step 570 may include taking as the first intermediate output (IO) the output of an output layer, in particular a classifier, stored inside the delegated neural network applet DNA. In the latter case the application with neural network NNA may not include an output layer OL.

The storing step 530 may include loading the delegated neural network applet DNA with the model in the secure element 23 using a remote delivering of the model by a secure channel or a confidential channel to the secure element 23, preferably by OTA (Over The Air) remote provisioning. In variant embodiments, the storing step 530 may include pre-storing or pre-loading the delegated neural network applet DNA, prior insertion of the secure element in the apparatus, for instance at the OEM or card maker.

In variant embodiments, the solution here described further includes a so called velocity mechanism.

As the solution described aims to protect the weights of the delegated neural network applet DNA and to impede tampering or cloning, since with a sufficient numbers of execution, the weights of the delegated neural network applet DNA may be possibly estimated by the outside.

Thus, the delegated neural network applet DNA includes a velocity mechanism which limits the number of executions performable by the applet DNA, e.g. to 10000 executions. In an embodiment the velocity mechanism may be implemented by a counter which is set to such limit number and the applet DNA is configured to be stop after the counter reaches the limit number and to supply its output information OI. The limit number of the velocity mechanism may be managed, e.g. disabled, by the OTA server in case it is available an information or certification that the execution of the applet DNA is legitimate.

In variant embodiments, the secure element 23 is personalized with a key K (symmetric or asymmetric), which is not known to the mobile application, i.e. to the applet DNA, but only to the storing entity, e.g. the OTA server but not to the mobile application. In case it is symmetric, the key K is pre-shared with OTA server. In case it is asymmetric, the OTA server knows the public key.

When the OTA server downloads the neural network NN to the application, the second portion NN2, e.g. the weights/structure are encrypted with the key of the target secure element 23.

Those information are then communicated to the secure element 23 encrypted, the secure element 23 is configured to decrypt such second portion NN2 and execute.

The described solution thus has several advantages with respect to the prior art solutions.

The solution here described allows a secure storage of neural network, weights and structure, which never leave the secure element. The secure storage allows IP protection and avoids network tampering (i.e. executing with different weights or manipulating in-between data).

Also, the solution here described advantageously, asking to the secure element to execute only part of the computation, improves the performances allowing faster computations.

Of course, without prejudice to the principle of the invention, the details of construction and the embodiments may vary widely with respect to what has been described and illustrated herein purely by way of example, without thereby departing from the scope of the present invention, as defined by the ensuing claims.

The first processing system may be the processor of a mobile device and the second processing system may be represented by an integrated card in the mobile device, a UICC card which comprises at least microprocessor, as the second processing system, and at least a memory, typically including a nonvolatile and a volatile portion. Such memory is configured to store data such as an operating system, applets such as the application comprising a model of the second portion of the neural network, and an MNO profile that a mobile device can utilize to register and interact with an MNO, in particular for performing the OTA remote provisioning operations. The UICC can be removably introduced in a slot of a device, i.e. a mobile device, or they can also be embedded directly into the devices (eUICC). The eUICC cards are particularly advantageous since for their nature are designed to remotely receive MNO profiles.

In variant embodiments, the apparatus may be any other apparatus which includes a first processing system for executing a first portion of the neural network and second processing system, external to the first processing system, configured to receive as input the first intermediate output of the first portion and configured to operate a second portion of the neural network, which may comprise a secure element to store the application comprising a model of the second portion, where the second processing system is configured to execute such second portion stored in the secure element of the neural network (XNN) applying the input information from the first portion to the model of the second portion. For instance the apparatus may be still a mobile device, and the secure element an eSE included in such mobile device, instead of an integrated card. In variant embodiments the first processing system may be a computer, the second processing system with secure element may be computer secure element such as the Trusted Platform Module (TPM). In further embodiments the apparatus is a car telematic system and the secure element a car secure element.

As indicated preferably the portion of the model of the neural network to be executed by the second processing system is stored in an application, in particular an applet, executable by such processing system, however such portion of the model of the neural network can be stored in a file or a memory portion or another container of data which can be accessed by the second processing system to operate such portion of the model of the neural network.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. An apparatus for operating a neural network comprising a set of neural network layers, the apparatus comprising:
a first processing system executing a first portion of the neural network comprising a first subset of the set of neural network layers obtaining a first intermediate output; and
a second processing system, external to the first processing system, configured to receive as input the first intermediate output of the first portion, and configured to execute a second portion of the neural network comprising a second subset of the set of neural network layers, obtaining a respective output;
wherein the second processing system is configured to supply, to the first processing system, output information as a function of the respective output;
wherein the first processing system is configured to obtain, as a function of the output information, a final output of the neural network;
wherein the second processing system includes a secure element storing a model of the second portion; and
wherein the second processing system is configured to execute the second portion of the neural network by applying the first intermediate output to the model of the second portion stored in the secure element to obtain the respective output.

2. The apparatus according to claim 1, wherein in the secure element is stored an application comprising the model of the second portion executable by the second processing system.

3. The apparatus according to claim 2, wherein the application includes a command to feed the first intermediate output to the model of the second portion.

4. The apparatus according to claim 2, wherein the application includes an inference engine receiving the respective output and outputting predictions.

5. The apparatus according to claim 1, wherein the model of the second portion includes an output layer, in particular a classifier.

6. The apparatus according to claim 1, wherein the first processing system include a further proxy application which is configured to operate as an interface to the second processing system and the secure element, obtaining the first intermediate output and supplying it to the second processing system and the secure element, and receiving the output information as the function of the respective output from the second processing system.

7. The apparatus according to claim 2, wherein the application comprising the model of the second portion includes a velocity mechanism which limits a number of executions performable by the application to a given limit number of executions, in particular includes a counter set to the given limit number of executions, the application comprising the model of the second portion being configured to stop when the counter reaches the given limit number of executions.

8. The apparatus according to claim 1, wherein the secure element is one of:
a Universal Integrated Circuit Card (UICC);
an embedded UICC (eUICC);
an embedded Secure Element (eSE); or
a removable memory card.

9. The apparatus according to claim 1, wherein the first processing system is a processor of a mobile device and the second processing system comprising the secure element is an integrated card in the mobile device.

10. A method for executing a neural network comprising a set of layers, the method comprising:
dividing a trained neural network into a first portion comprising a first set of layers and a second portion comprising a second set of layers;
storing the first portion in a memory accessible by a first processing system, for operation by the first processing system;
storing an application comprising a model of the second portion in a secure element associated with a second processing system external to the first processing system;
operating the first portion obtaining a first intermediate output;
supplying the first intermediate output as intermediate input to the application comprising the model of the second portion in the secure element;
executing in the secure element the second portion obtaining a respective output; and
supplying to the first processing system output information as a function of the respective output.

11. The method according to claim 10, wherein the supplying to the first processing system the output information as the function of the respective output includes one of the following:
feeding the respective output to an inference engine of the application to obtain predictions, which are sent back as intermediate output information to the first processing system to be outputted as final information;
taking as the first intermediate output an output of hidden layers of the neural network; or
taking as the first intermediate output an output of an output layer, in particular a classifier, stored inside the application.

12. The method according to claim 10, wherein storing the application comprising the model of the second portion in the secure element includes remotely delivering the model by a secure channel or a confidential channel to the secure element.

13. The method according to claim 12, wherein storing the application comprising the model of the second portion in the secure element includes loading the model in the secure element using over-the-air (OTA) remote provisioning.

14. The method according to claim 13, wherein an OTA server loads in the secure element the application comprising the model of the second portion encrypted with a given key specific to the secure element, the secure element being configured to decrypt with the given key the second portion and to perform the executing the second portion.

15. The method according to claim 10, wherein the model comprises a description of cells, connections, and weights and functions associated with the cells and the connections, of the second portion of the neural network.

16. The method according to claim 10, wherein the supplying the first intermediate output is performed by a proxy application of the first processing system.

17. A computer-program product loadable into a memory of at least one processor and comprising portions of software code for implementing the following steps:
dividing a trained neural network into a first portion comprising a first set of layers and a second portion comprising a second set of layers;
storing the first portion in a memory accessible by a first processing system, for operation by the first processing system;
storing an application comprising a model of the second portion in a secure element associated with a second processing system external to the first processing system;
operating the first portion obtaining a first intermediate output;
supplying the first intermediate output as intermediate input to the application comprising the model of the second portion in the secure element;
executing in the secure element the second portion obtaining a respective output; and
supplying to the first processing system output information as a function of the respective output.

18. The computer-program product according to claim 17, wherein the supplying to the first processing system the output information as the function of the respective output includes one of the following:
feeding the respective output to an inference engine of the application to obtain predictions, which are sent back as intermediate output information to the first processing system to be outputted as final information;
taking as the first intermediate output an output of hidden layers of the trained neural network; or
taking as the first intermediate output an output of an output layer, in particular a classifier, stored inside the application.

19. The computer-program product according to claim 17, wherein storing the application comprising the model of the second portion in the secure element includes remotely delivering the model by a secure channel or a confidential channel to the secure element.

20. The computer-program product according to claim 19, wherein storing the application comprising the model of the second portion in the secure element includes loading the model in the secure element using over-the-air (OTA) remote provisioning.
